(19) United States
(12) Patent Application Publication
(10) Pub. No.: US 2015/0046807 A1
(43) Pub. Date: Feb. 12, 2015

(54) Asynchronous Rich Media Messaging

(71) Applicant: Gface GmbH, Frankfurt/Main (DE)

(72) Inventor: Cevat Yerli, Frankfurt/Main (DE)

(21) Appl. No.: 13/961,742

(22) Filed: Aug. 7, 2013

(51) Int. Cl. G06Q 50/00; G06F 3/0484; G06F 3/0482

(52) U.S. Cl. CPC G06Q 50/01; G06F 3/0482; G06F 3/04842
USPC 715/716

(57) ABSTRACT

An access device for a first user to access an online social network comprises a network interface, a display, a user input device, and logic. The logic is configured to display indications of a plurality of other users on the display, and receive, via the user input device, a selection of at least one of the other users. The logic is further configured to, in response to receiving the selection, display a recording menu on the display, the recording menu comprising a start button, and, in response to the first user activating the start button, record a first media file, and transmit the recorded first media file along with an identification of the selected at least one other user to a server of the online social network. Moreover, other access devices and a server are provided.

### FIELD

The present disclosure relates to the field of media messaging and, in particular, to transmitting and receiving media messages in an asynchronous manner.

### BACKGROUND

Modern communication technologies have provided users with the possibility to conduct conferences remotely using one of several types of media. In a video conference, for example, a first user may transmit video data to a second user. The second user may then view the video data of the first user instantaneously, i.e., as soon as the data arrive at the second user's access device. In other words, in a video conference, it is intended that the video data are captured and played without a noticeable delay, i.e., in a synchronous manner.

However, there is an ongoing need for an access device, a system and a method for allowing a first user to record various types of media messages, which may then be played back by another user at any time after the recording in an asynchronous manner.

### SUMMARY AND INITIAL DESCRIPTION

The present disclosure solves the above-mentioned problem by providing, in a first aspect, an access device for a first user to access an online social network. The access device comprises a network interface for coupling to the online social network, a display, a user input device and logic coupled to the network interface, the user input device, and the display. The logic is configured to display indications of a plurality of other users of the online social network on the display, and receive, via the user input device, a selection of at least one of the other users. The logic is further configured to, in response to receiving the selection, display a recording menu on the display, the recording menu comprising a start button, and, in response to the first user activating the start button using the user input device, record a first media file, and transmit the recorded first media file along with an identification of the selected at least one other user to a server of the online social network.

The first user may thus easily select another user of the online social network for whom the first user wants to record a media message. The indications of the plurality of other users may, for example, be displayed in a list, an array, or the like. For each user, the indication may, e.g., comprise a name, a nickname, an image, a photo, an animation, and/or anything else that identifies the respective user. As the identification of the selected other user is transmitted along with the recorded media file, privacy of the recorded media file is improved. This provides benefits over known systems, in which media files, such as video files, may be publicly posted on a website. In particular, the server receiving the media file may, in some instances, only grant access to the media file for one or more users, whose identifications were received along with the received media file.

The access device of the present disclosure may refer to any device that a user may utilize to access the online social network. In particular, the access device may comprise a personal computer (PC), a laptop computer, a netbook, a handheld device, a smartphone, a personal digital assistant (PDA), a tablet PC, a TV set, etc.

In some embodiments, the logic is configured to receive, via the user input device, a selection of two or more of the other users and to transmit the recorded first media file along with identifications of the selected at least two other users to the server.

According to a preferred embodiment, recording the first media file comprises at least one of recording an audio file and recording a video file. Additionally or alternatively, the first media file may comprise an e-mail, a text, one or more images, and/or one or more animations. In some embodiments, the first media file does not exclusively consist of a text and/or an e-mail.

In a preferred embodiment, in response to the first user activating the start button, the logic records at least one second media file, wherein the logic transmits the recorded second media file along with the recorded first media file and the identification of the selected at least one user to the server of the online social network. This embodiment enables the first user to provide a plurality of media files to the second user, conveying a larger amount of information.

Alternatively or additionally, the recording menu may comprise a second start button and, in response to the first user activating the second start button, the logic records at least one second media file, wherein the logic transmits the recorded second media file along with the recorded first media file and the identification of the selected at least one user to the server of the online social network.

It is, in particular, preferred that the first media file is of a first media format and the second media file is of a second media format, wherein the first media format is different from the second media format. For example, the first media file may be an audio file, and the second media file may be a video file. Alternatively, the first media file may be one of an audio file and a video file, and the second media file may be one of an audio file, a video file, an image file, an animation file, a text, or an e-mail. For example, the first media file may be an audio file, in which the first user verbally describes a gallery that the first user wants to visit, and the second media file is a map showing the directions to that gallery.

In some embodiments, the recording menu further includes a file menu, wherein one or more previously stored files are selectable via the file menu, e.g., using the user input device. In these embodiments, the first user may select a pre-recorded file via the file menu. The logic may then be further configured to transmit the selected one or more previously stored files along with the first media file and the identification of the selected at least one other user to the server. The previously stored files may be pre-recorded files, and may, for example, be stored locally, or may be accessible over a network, such as an intranet or the Internet.

In some embodiments, the access device further comprises a recording device and/or may be adapted to be operatively coupled to a recording device. The recording device may, for example, comprise a still camera, a video camera, and/or a microphone. The recording device may be coupled to the logic, such that the logic may record the first media file and/or the second media file using the recording device.

In a preferred embodiment, the logic is further adapted to transmit a notification to the selected at least one other user that at least one media file has been transmitted for the selected at least one other user. This allows the second user to be informed about the recorded media file, independently from playing back the media file. For example, the notification may comprise an e-mail, an SMS and/or a chat message. After having been notified about the transmitted media file(s), the second user may then decide to retrieve and/or play the media file at any time he or she wishes to. It is, in particular, preferred that the notification does not contain the first media file itself, or only contains a portion, such as a preview, of the first media file. Similarly, it is preferred that the notification does not contain the second media file itself, or only contains a portion, such as a preview, of the second media file.

In a preferred embodiment, the indications of the plurality of other users and/or the recording menu are displayed within a user interface of the online social network. For example, the indications and/or the recording menu may be displayed within a same window as a chat function of the online social network.

According to a preferred embodiment, the user input device comprises a pointing device, wherein a pointer is displayed on the display, and the pointer is moveable by moving the pointing device. In this embodiment, the at least one of the other users may be selected when the pointer is moved over the indication of the at least one of the other users.

It is, in particular, preferred that the selection of the at least one of the other users is received when the pointer is moved over the indication of the at least one of the other users and remains over the indication for a predetermined period of time. In some embodiments, in which the pointing device is, e.g., a computer mouse, the first user is thus not required to click on a button of the mouse. Rather, one of the other users may simply be selected by placing and leaving the pointer over the indication of that other user at least for a predetermined period of time. In some embodiments, the period of time is predetermined by the first user, for example via an “options” menu shown on the display. Alternatively or additionally, the predetermined period of time may be between 0.5 seconds and 5 seconds, in particular, between 0.8 seconds and 4 seconds, and, preferably, between 1 second and 2 seconds.

In some embodiments, the recording menu further comprises a stop button, and the recording of the first and/or the second media file is terminated when the first user activates the stop button. The first user may, for example, activate the stop button using the user input device. In some embodiments, the logic automatically transmits the first media file and the identification of the selected at least one user and, possibly, the second recorded media file, in response to the first user terminating the recording of the first media file, e.g., by activating the stop button. In this embodiment, the first media file is automatically transmitted to the server when the recording is terminated. Hence, the first user does not have to take any more actions for causing a transmission.

In some embodiments, the first media file is transmitted when recording of the first media file is terminated. In these embodiments, in particular, the transmission may start when the recording is terminated.

However, alternatively or additionally, the recording menu may comprise a transmission button. The transmission button may, e.g., only be displayed when recording of the first and/or second media files has terminated. The logic may be adapted to, in response to the first user selecting the transmission button, e.g., using the user input device, transmit the recorded first media file and the identification of the at least one second user to the server.

In some embodiments, the recording menu further comprises a pause button, and the recording of the first media file is paused when the first user activates the pause button, e.g., using the user input device. Recording the first media file may be continued when the first user activates the pause button again, for example, using the user input device. Similarly, recording the second media file may be paused when the first user activates the pause button and, recording the second media file may be continued, when the first user activates the pause button again.

In a further aspect, a computer-implemented method is provided, which comprises displaying, for a first user, indications of a plurality of other users of an online social network on a display; receiving, from the first user, a selection of at least one of the other users; in response to receiving the selection, displaying a recording menu on the screen, the recording menu comprising a start button; in response to the first user activating the start button, recording a first media file; and, in response thereto, transmitting the recorded first media file along with an identification of the selected at least one other user to a server of the online social network.

Moreover, in some embodiments, a machine-readable medium, preferably a non-transitory machine-readable medium, may be provided, having instructions stored thereon that, when executed by a machine, cause the machine to execute the described method.

In yet a further aspect, a server is provided, comprising a network interface for coupling to a first access device of a first user and a second access device of a second user, a storage and a logic coupled to the network interface and the storage. The logic is configured to receive a first media file along with an identification of at least the second user from the first access device via the network interface; and, in response thereto, storing the first media file in the storage and transmitting, via the network interface, a notification to the second access device that the first media file is available for the second user.

In some embodiments, the server may be hosting at least a part of an online social network. The storage may comprise a volatile or a non-volatile storage medium, such as a magnetic or an optical storage medium, a hard disk drive, or the like.

In some embodiments, the logic is configured to store the first media file in the storage along with an identification of the first access device, the second access device, the first user, and/or the second user.

In some embodiments, the logic is further configured to receive, along with the first media file and the identification of the second user, an identification of at least a third user. In this embodiment, the logic may further be configured to transmit, via the network interface, a notification to a third access device associated with the third user that the first media file is available for the third user.

In a preferred embodiment, the logic is further configured to receive, via the network interface, an indication request from the second access device to receive indications of media files that are available for the second user. In response thereto, the logic may, for example, transmit indications of previously received media files stored in the storage, that are stored along with an identification of the second user.

According to a preferred embodiment, the logic is further configured to receive, via the network interface, a transmission request for the first media file from the second access device. In response thereto, the logic may, for example, transmit the first media file stored in the storage to the second access device via the network interface.

In some embodiments, the logic is configured to grant, in response to an indication and/or transmission request, access to a media file stored in the storage only when an identification of the requesting user included in the indication or transmission request, respectively, corresponds to an identification that is stored in the storage along with the media file. For example, only the user(s) for whom the media files had been recorded and transmitted will be able to access the media files.

In yet a further aspect, an access device for a second user to access an online social network is provided. The access device comprises a network interface for coupling to the online social network, a display, a user input device and logic coupled to the network interface, the user input device, and the display. The logic is configured to receive, via the network interface, from the online social network, an indication of a pre-recorded first media file transmitted by a first user of the online social network for the second user; display a message field including the indication on the display; and, in response to the second user activating the indication using the user input device, play the first media file.

The network interface may, for example, comprise a wired or wireless network interface, such as a LAN or a WLAN interface. The display and the user input device may, in some embodiments, be integrated, for example, into a touch-sensitive display.

In a preferred embodiment, the pre-recorded first media file includes at least one of an audio file and a video file. In particular, the first media file may in some embodiments not consist only of text or an e-mail.

According to a preferred embodiment, the message field includes a time slider that allows time scrubbing of the pre-recorded first media file by the second user while playing the first media file. In this embodiment, the second user may browse or skip through the first media file.

In a preferred embodiment, the message field further includes an identification of the first user. The identification of the first user may, e.g., have been received along with the indication of the first media file. In this way, the second user is informed about the identity of the recording party.

In a preferred embodiment, the message field further includes an identification of a user of the online social network that last changed the previous recorded message. The identification of the user may, e.g., have been received along with the indication of the first media file. For example, the first user may have recorded and transmitted the first media file for a plurality of other users. One of the other users may be enabled to modify or change the pre-recorded first media file. For example, he or she may have added information to the first media file or have removed information therefrom.

In a preferred embodiment, the logic, in response to the second user activating the message field and before playing the first media file, retrieves the first media file from the online social network via the network interface. In this embodiment, the first media file is only retrieved from the online social network, such as from a server of the online social network, when the second user actively selects to view the first media file. Hence, transmission of the first media file is avoided when the second user does not want to enjoy the first media file. Hence, bandwidth requirements are reduced.

However, in some embodiments, the logic is adapted to receive, along with the indication of the first media file, a portion, such as a preview, of the first media file, and may further be adapted to play the received portion. For example, the logic may play the received portion when displaying the indication on the display.

According to a preferred embodiment, the logic is further configured to receive, via the network interface, from the online social network, a second indication of a second pre-recorded media file transmitted by the first user for the second user, and the displayed message field also includes the second indication. In response to the second user activating the second indication via the user input device, the logic may play the second media file. This embodiment allows the second user to view and browse through different media files sent from the first user to the second user.

In some embodiments, the message field comprises selection means for selecting one or more media files from the first user, for which indications have previously been received. An indication of one or more of the one or more media files may be activated by selecting the one or more media files using the selection means, e.g., using the user input device. The selection means may, e.g., comprise a list including check boxes, an input field, a slider, etc.

In some embodiments, the first user may indicate that a media file was recorded or transmitted for a second user by transmitting the media file along with an identification of the second user. Similarly, the first user may indicate that a media file was recorded or transmitted for a group of users by transmitting the media file along with identifications of each of the group of users or an identification of the group of users.

The access device may comprise a rendering device adapted to play the first and/or second media file and/or portions thereof. The rendering device may, e.g., comprise loudspeakers, headphones, a second display, etc. Alternatively or additionally, the logic may be configured to play the first and/or second media file and/or a portion thereof using the display of the access device.

In a preferred embodiment, the message field further includes a first recording button, and the logic is further configured, in response to the second user activating the first recording button using the user input device, to record a response media file, and transmit the response media file to the online social network, such as, for example, a server of the online social network, via the network interface. This embodiment enables the second user to conveniently respond to the message from the first user. In particular, as the second user may already have chosen to see media files transmitted from the first user, the second user does not need to select the first user again or to input the first user's identification when wanting to reply to the first media file. Instead, the second user may conveniently activate the recording button, for example, by clicking on the first recording button. Along with the response media file, identifications of the first user, the second user, the first access device and/or the second access device may be transmitted.

According to a preferred embodiment, the first recording button corresponds to an audio recording button, and the response media file is a response audio file. Alternatively, the first recording button may correspond to a video recording button, and the response media file corresponds to a response video file.

It is further preferred that the message field includes a second recording button, and the logic is further configured, in response to the second user activating the second recording button using the user input device, to record a response video file, and transmit the response video file to the online social network via the network interface. Along with the response video file, identifications of the first user, the second user, the first access device, and/or the second access device may be transmitted.

In a preferred embodiment, the logic is configured to display indications of a plurality of other users of the online social network on the display, including the first user, and the logic displays the message field in response to receiving a selection of the first user from the second user using the user input device. For example, the user input device may comprise a pointing device, such as a computer mouse. The logic may be configured to display a pointer on the display, which is moveable by moving the pointing device. In this embodiment, the first user may automatically be selected when the pointer is moved over the indication of the first user and remains over the indication of the first user for a predetermined period of time.

In some embodiments, a computer-implemented method is provided that comprises receiving, via a network interface, from an online social network, an indication of a pre-recorded first media file transmitted by a first user of the online social network for a second user; displaying a message field including the indication; and, in response to the second user activating the indication, playing the first media file.

### DESCRIPTION OF THE DRAWINGS

Further features and benefits of the present disclosure will become apparent to the skilled person when reading the following detailed description in conjunction with the accompanying figures, in which:

FIG. 1 shows a graphical user interface displayed for a first user of an access device according to an embodiment;

FIG. 2 shows another graphical user interface displayed for the first user of an access device according to an embodiment;

FIG. 3 shows another graphical user interface displayed for the first user of an access device according to an embodiment;

FIGS. 4A and B show graphical user interfaces displayed for a second user of an access device in respective embodiments, respectively; and

FIG. 5 shows a schematic view of a system comprising two access devices and a server according to some embodiments of the present disclosure.

### DETAILED DESCRIPTION

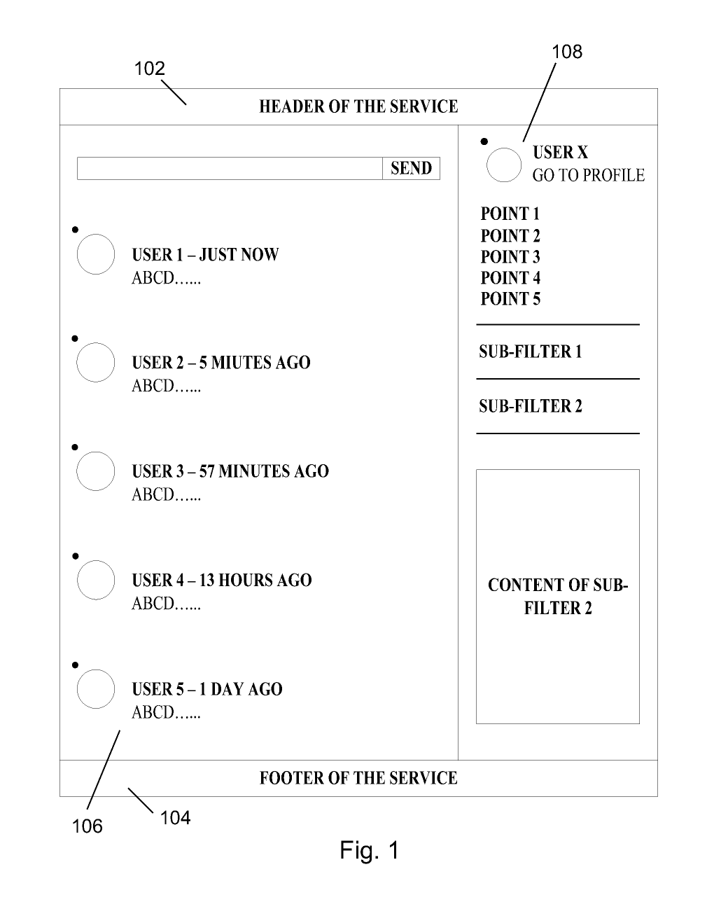

FIG. 1 shows a graphical user interface displayed for a first user of an access device according to an embodiment. In particular, the user interface of FIG. 1 may be displayed on a display of the first user's access device, such as a laptop computer or a smartphone. The graphical user interface shown in FIG. 1 is a user interface of an online social network. At the top of the interface, a header of the service 102 is shown, which may, e.g., indicate a name of the online social network, a user name of the first user, a current time or date, etc. Moreover, a footer of the service 104 is displayed at the bottom of the user interface of FIG. 1. The footer of the service may provide additional information to the first user, such as a current time or date, etc.

In addition, a main area 106 is included in the interface of FIG. 1, showing indications of other users of the online social network, in this case five other users, with whom the first user has previously interacted. To the left of each user name, one or more icons may be displayed for each of the users, as indicated by a circle in FIG. 1. The one or more icons displayed along with each user name may be icons that the respective user has previously selected, or that the first user has assigned to the respective other user. In addition to the user name and the one or more icons for that user, the elapsed time since the last interaction between the respective user and the first user is displayed. For example, the first user is interacting with USER 1 just now, for instance, the first user may be engaged with USER 1 in a chat conversation. As a further example, the first user may have interacted with USER 2 five minutes ago. For example, the first user may have sent USER 2 a video file five minutes ago.

In a further area 108 of the graphical user interface of FIG. 1, details of one of the users may be displayed, in this case, details regarding USER X. For example, the first user may select one of the users in the main area 106 and, subsequently, further information about the selected user is displayed in the area 108. In the area 108, the name of the user, in this case USER X, is displayed along with one or more icons associated with USER X. Moreover, additional items of information may be displayed, as indicated by POINT 1 to POINT 5 in FIG. 1. For example, POINT 1 may refer to an e-mail address, POINT 2 to a street address, POINT 3 to a hobby of USER X, etc.

Moreover, in area 108 the first user may select one or more sub-filters for organizing the display in the main area 106. For example, using sub-filter 1, the first user may decide that only other users that have been online within the last week will be displayed in the main area 106. Alternatively or additionally, using sub-filter 1 or 2, the user may decide that only other users are displayed in the main area 106 that have street addresses that are close to the first user. At the bottom of the area 108, the content of sub-filter 2 is displayed.

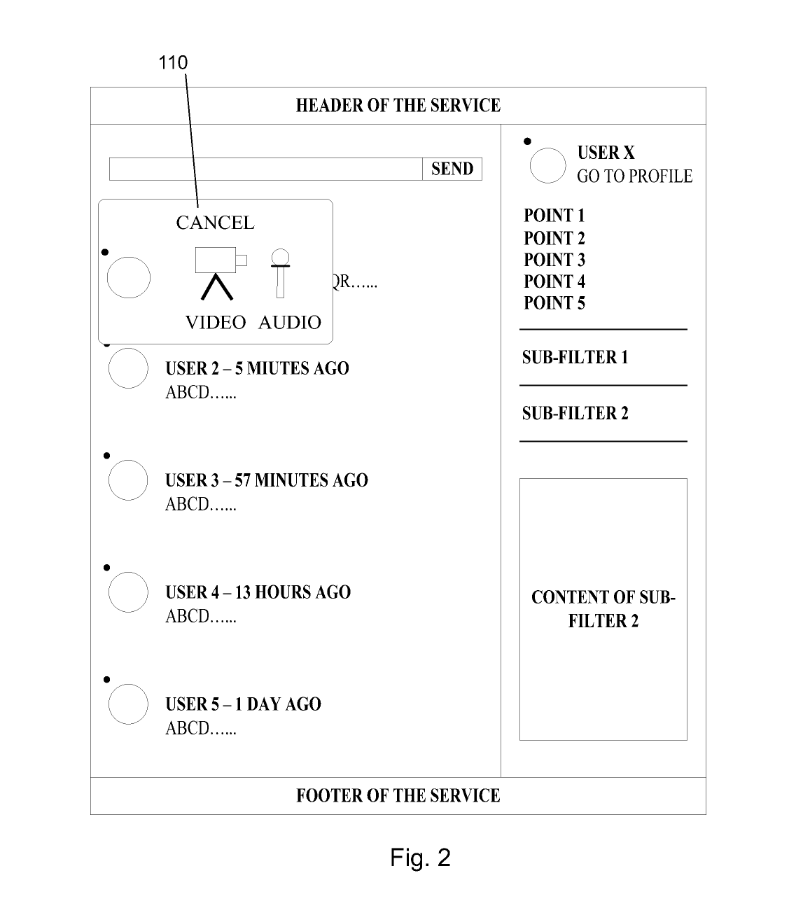

The graphical user interface of FIG. 1 may, for example, be displayed on the display of an access device, such as a laptop computer. Using the mouse of the laptop, the first user may move a pointer over one of the icons associated with the users in the main area 106 of FIG. 1. In some embodiments, without having to click or press any key, one of the user names shown in the main area 106 of FIG. 1 will be automatically selected when the mouse pointer remains over the respective icon for a predetermined amount of time. In that case, a recording menu 110 will be displayed, as shown in FIG. 2. For example, the first user may have moved the mouse pointer over the icon associated with USER 1 in the main area 106 of FIG. 1 and left it there for about one second. Subsequently, the recording menu 110 shows up, as displayed in FIG. 2. In the recording menu 110, the one or more icons associated with USER 1 are shown and, moreover, a first recording button labeled “VIDEO” and a second recording button labeled “AUDIO” are displayed. Moreover, a button labeled “CANCEL” is shown in the recording menu 110. By selecting the “CANCEL” button, the first user may leave the recording menu 110 and return to the graphical user interface of FIG. 1.

However, by selecting the first recording button labeled “VIDEO,” the first user may initialize recording of a video. For example, the access device may be included or be coupled to a recording device, such as a video camera, a webcam, or the like. When the first user activates the button labeled “VIDEO,” the access device will start recording a video using the recording device. Similarly, when activating the second recording button labeled “AUDIO,” for example, using the mouse pointer or another user input device, recording of an audio file will begin.

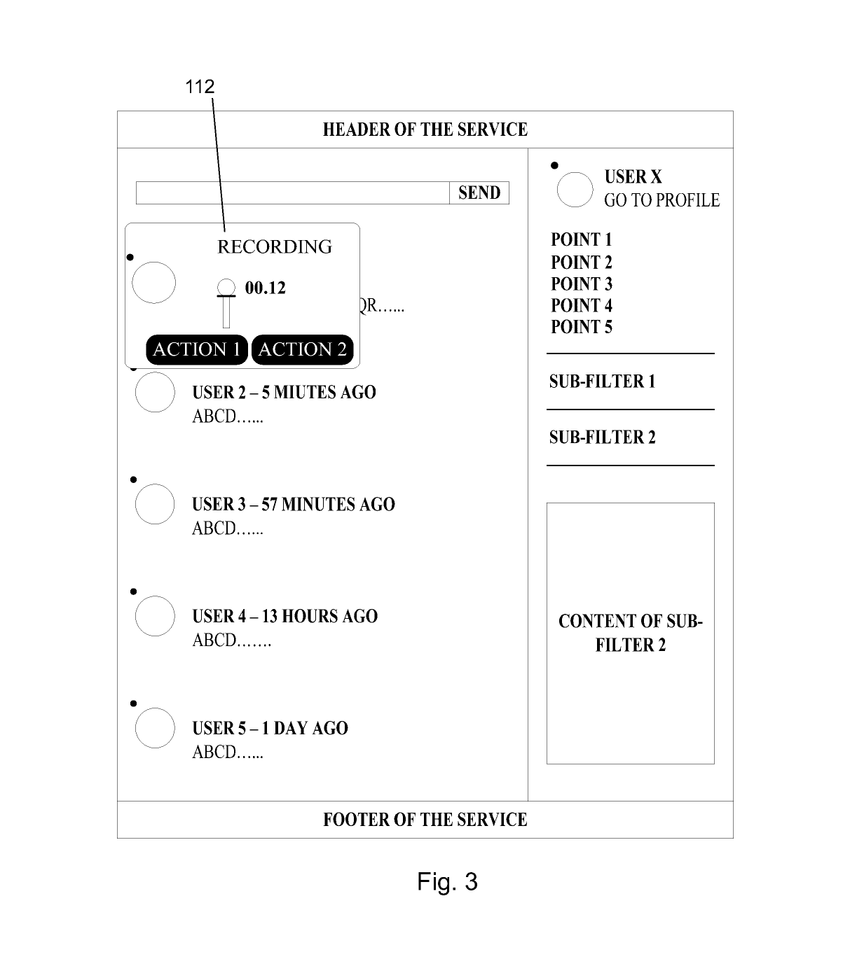

FIG. 3 shows another graphical user interface shown to the first user of the access device, when the first user activates the first or the second recording button within the recording menu 110 of FIG. 2. In the graphical user interface of FIG. 3, a recording menu 112 is shown, which displays one or more icons associated with user 1. Moreover, it is indicated that the access device is “RECORDING.” Additionally, an audio recording condition is shown, like, for example, the current audio level. Moreover, the time since recording has begun is displayed, as indicated by 00.12 in the recording menu 112 of FIG. 3, corresponding to a recording time of 12 seconds. In addition, two buttons “ACTION 1” and “ACTION 2” are displayed within the recording menu 112. Any of these buttons may, e.g., refer to starting, stopping, pausing, clearing, etc., of the recording. In some embodiments, when the recording has been terminated, for example, by the first user activating a stop button, the access device will automatically transmit the recorded media file along with an identification of USER 1 and, optionally, an identification of the first user to a server of the online social network. Moreover, a notification is sent to USER 1, either directly from the first user's access device or from the server of the online social network.

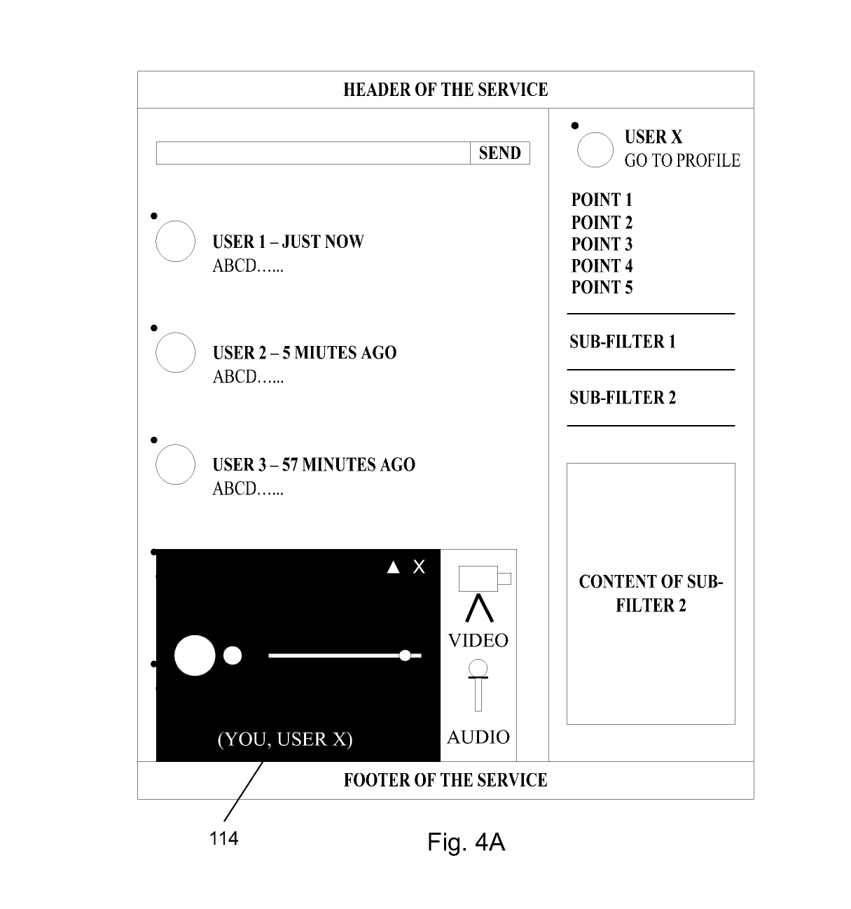

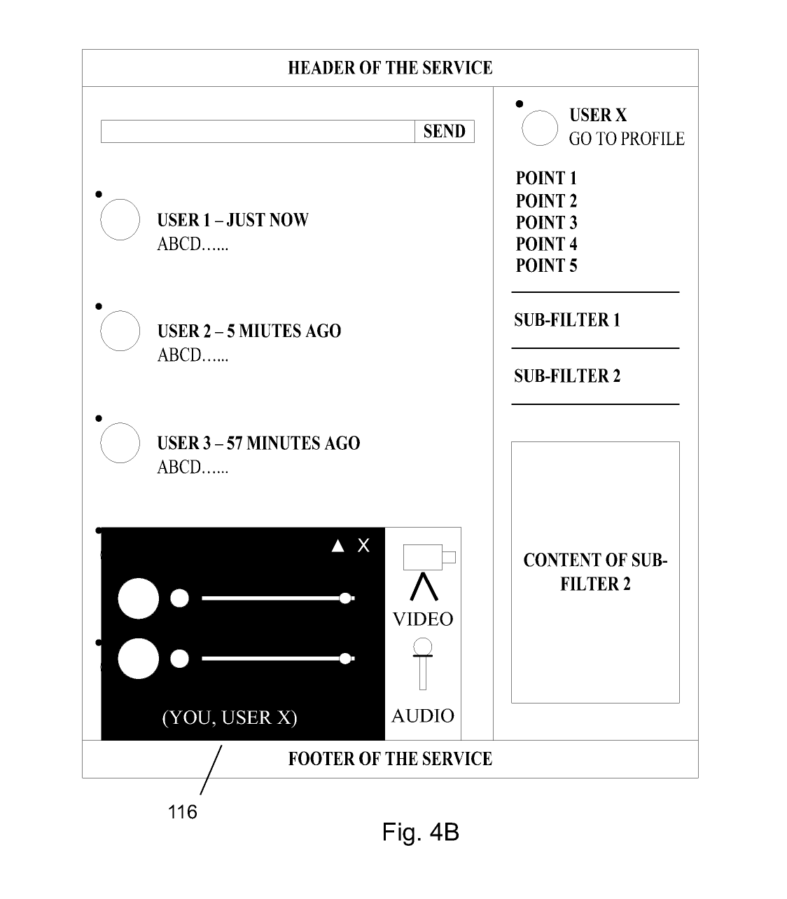

FIG. 4A shows as graphical user interface displayed for a second user associated with another or the same access device according to an embodiment. The graphical user interface of FIG. 4A is similar to a graphical user interface that may be displayed for the first user, such as the user interface shown in FIG. 1. In the graphical user interface of FIG. 4A, the second user may select one of the users, for example USER X, to be provided with the media files that USER X has previously recorded for the second user. For example, the second user may move his mouse pointer over the icon of USER X in the main area of the graphical user interface of FIG. 4A and leave it there for at least a predetermined amount of time to select USER X.

In the graphical user interface of FIG. 4A, a message field 114 is displayed. At the bottom of message field 114, the name of the second user (YOU) and the name of the selected other user (USER X) is shown. Moreover, in the left region of the message field 114, an icon of USER X is shown. In a central portion of the message field 114, a time slider is displayed. Using the time slider, the second user may time scrub one of the media files from USER X, or may browse through different media files previously received from USER X.

In addition, on the right hand side of the message field 114, a first recording button labeled “VIDEO” and a second recording button labeled “AUDIO” are displayed. By activating any of the recording buttons “VIDEO” and “AUDIO”, the second user is enabled to record a response media file for USER X. For example, when one of the recording buttons is activated, a recording menu similar to recording menu 110 as shown in FIG. 2 may be displayed for the second user. When recording of the response media file is terminated, the response media file may be transmitted from the second user's access device to the server of the online social network. Transmission may e.g. further comprise identifications of the first user and the second user.

In FIG. 4B, a graphical user interface similar to the graphical user interface of FIG. 4A is shown. In the user interface of FIG. 4B, a message field 116 is displayed, which includes two time sliders. Using a first time slider, the second user may time scrub through a most recent media file received from USER X. Using the second time slider, for example, the second user may browse through different media files previously received from USER X.

For example, a first user, who is an organizer of a club, needs to send a media message to a large number of club members regarding a change of venue for an upcoming club meeting. Using an embodiment of the present disclosure, the first user may select one or more of different media types, such as an audio file or a video file. In this example, the organizer could record and leave a voice message as an audio file for club members. However, according to an embodiment, the organizer may additionally provide an image of a map detailing the exact directions to the new venue. For example, the first user may use a file menu (not shown) included in the recording menu to transmit a selected file, such as an image showing a map, along with the recorded audio file and identifications of the club members or an identification of the club to a server.

In addition, the video messaging facility according to an embodiment provides an extremely efficient and cost-effective solution in reaching a large distributed audience. The possibilities are vast, for example, a lecturer could explain a complex mathematical problem on a whiteboard to a group of students on a distance learning program, or a technical manager could explain the meaning of some technical instructions to a group of field service engineers or give a practical demonstration of a task to some apprentice trainees. It could also include giving a presentation.

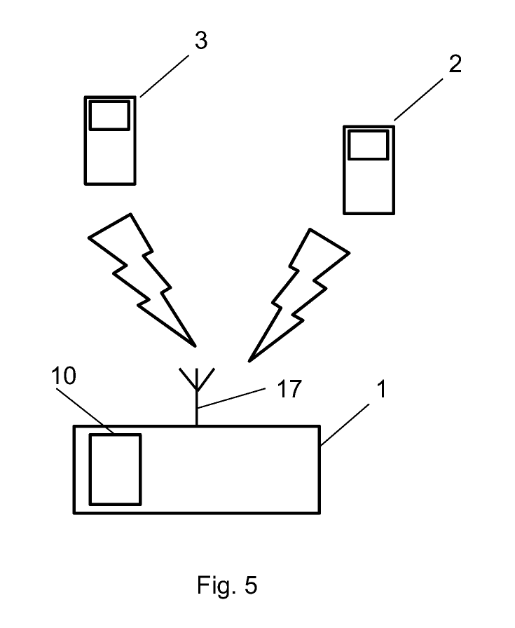

FIG. 5 shows a schematic view of a system comprising two access devices 2, 3 and a server 1 according to at least some embodiments. A first user may use a first access device 2 to record one or more media files, such as audio files or video files. After recording the media files is complete, e.g., recording has been terminated, the recorded media files are transmitted from the first access device 2 to a remote server 1 along with one or more indications of recipients of the media files. The remote server 1 is equipped with an antenna 17 to receive the transmitted media files along with the identifications. The server 1 includes logic (not shown) and storage 10. Upon receiving the media files and identifications from the first access device 2, the first server 1 stores the received media files within the storage 10 along with the identifications of the recipients received from the access device 2. Moreover, the server 1 sends a notification to an access device 3 that is associated with one of the recipients, such as a second user of the online social network. With the notification, the second user is informed that there has been a media file made available to him. In some embodiments, the notification also includes an identification of the first user, the first access device, a number of transmitted media files, a type of transmitted media files, portions, such as previews thereof, or the like. The second user operating the second access device 3 may then request transmission of the media files from the server 1, while transmitting his own identification. In response to receiving the request, server 1 may check whether the requested media file is stored in the storage 10 along with an identification which matches that of the second user and, if this is the case, transmit the stored media file to the second access device 3, e.g., using antenna 17.

Many variations, substitutions, and changes of the described embodiments will be apparent to the skilled person. For example, in some embodiments, the access device may be a tablet PC, a smartphone, a PDA, etc. In particular, the access device may comprise a touch-sensitive display, which includes the display and the user input device.

The embodiments of the invention in which an exclusive property or privilege is claimed are defined as follows:

1. An access device for a first user to access an online social network, comprising:
a network interface for coupling to the online social network;
a display;
a user input device; and
logic coupled to the network interface, the user input device, and the display, wherein the logic is configured to:
display indications of a plurality of other users of the online social network on the display;
receive, via the user input device, a selection of at least one of the other users;
in response to receiving the selection, display a recording menu on the display, the recording menu comprising a start button;
in response to the first user activating the start button using the user input device, record a first media file; and
transmit the recorded first media file along with an identification of the selected at least one other user to a server of the online social network.

2. The access device of claim 1, wherein recording the first media file comprises at least one of recording an audio file and recording a video file.

3. The access device of claim 1, wherein the recording menu comprises a second start button and wherein, in response to the first user activating the second start button, the logic records at least one second media file, and wherein the logic transmits the recorded second media file along with the recorded first media file and the identification of the selected at least one user to the server of the online social network.

4. The access device of claim 3, wherein the first media file is of a first media format and the second media file is of a second media format, wherein the first media format is different from the second media format.

5. The access device of claim 1, wherein the logic is further adapted to transmit a notification to the selected at least one other user that at least one media file has been transmitted for the selected at least one other user.

6. The access device of claim 1, wherein the indications of the plurality of other users and/or the recording menu are displayed within a user interface of the online social network.

7. The access device of claim 1, wherein the user input device comprises a pointing device, wherein a pointer is displayed on the display, wherein the pointer is moveable by moving the pointing device, and wherein the at least one of the other users is selected when the pointer is moved over the indication of the at least one of the other users.

8. The access device of claim 7, wherein the selection of the at least one of the other users is received when the pointer is moved over the indication of the at least one of the other users and remains over the indication for a predetermined period of time.

9. A server comprising:
a network interface for coupling to a first access device of a first user and a second access device of a second user;
a storage; and
logic coupled to the network interface and the storage, wherein the logic is configured to:
receive a first media file along with an identification of at least the second user from the first access device via the network interface; and
in response thereto, store the first media file in the storage and transmit, via the network interface, a notification to the second access device that the first media file is available for the second user.

10. An access device for a second user to access an online social network, comprising:
a network interface for coupling to the online social network;
a display;
a user input device; and
logic coupled to the network interface, the user input device and the display, wherein the logic is configured to:
receive, via the network interface, from the online social network, an indication of a pre-recorded first media file transmitted by a first user of the online social network for the second user;
display a message field including the indication on the display; and,
in response to the second user activating the indication using the user input device, play the first media file.

11. The access device of claim 10, wherein the pre-recorded first media file includes at least one of an audio file and a video file.

12. The access device of claim 10, wherein the message field includes at least one of a time slider that allows time scrubbing of the pre-recorded first media file by the second user while playing the first media file, and selection means that allow the second user to select one or more media files previously received from the first user.

13. The access device of claim 10, wherein the message field further includes an indication of the first user.

14. The access device of claim 10, wherein the message field further includes an indication of a user of the online social network that last changed the pre-recorded first media file.

15. The access device of claim 10, wherein the logic, in response to the second user activating the message field and before playing the first media file, retrieves the first media file from the online social network via the network interface.

16. The access device of claim 10, wherein the logic is further configured to:
receive, via the network interface, from the online social network, a second indication of a second pre-recorded media file transmitted by the first user for the second user, wherein the displayed message field also includes the second indication; and
in response to the second user activating the second indication via the user input device, play the second media file.

17. The access device of claim 10, wherein the message field further includes a first recording button, and wherein the logic is further configured, in response to the second user activating the first recording button using the user input device, to record a response media file, and transmit the response media file to the online social network via the network interface.

18. The access device of claim 17, wherein the first recording button corresponds to an audio recording button, and wherein the response media file is a response audio file.

19. The access device of claim 18, wherein the message field includes a second recording button, and wherein the logic is further configured, in response to the second user activating the second recording button using the user input device, to record a response video file, and transmit the response video file to the online social network via the network interface.

20. The access device of claim 10, wherein the logic is configured to display indications of a plurality of other users of the online social network on the display, including the first user, and wherein the logic displays the message field in response to receiving a selection of the first user from the second user using the user input device.
